(19) United States
(12) Patent Application Publication
(10) Pub. No.: US 2014/0107984 A1
(43) Pub. Date: Apr. 17, 2014

(54) GENERATION METHOD, DESIGN METHOD, MANUFACTURING METHOD OF OPTICAL SYSTEM, AND STORAGE MEDIUM

(71) Applicant: CANON KABUSHIKI KAISHA, Tokyo (JP)

(72) Inventors: Wataru YAMAGUCHI, Utsunomiya-shi (JP); Hideki INA, Tokyo (JP)

(73) Assignee: CANON KABUSHIKI KAISHA, Tokyo (JP)

(21) Appl. No.: 14/047,054

(22) Filed: Oct. 7, 2013

(30) Foreign Application Priority Data
Oct. 16, 2012 (JP) 2012-229241

(51) Int. Cl. G06F 17/50

(52) U.S. Cl. CPC G06F 17/50
USPC 703/1

(57) ABSTRACT

The present invention provides a generation method of generating, by a computer, initial data to be used when designing an optical system in which a plurality of lenses are arranged in an optical axis direction, wherein in an optical system model in which a thickness of each lens and intervals between the plurality of lenses are set to 0, letting m be the number of lenses, r₂ᵢ₋₁ and r₂ᵢ be curvature radii of two surfaces of an ith lens, respectively, and I₁ and I₂ be a first index and a second index, respectively, the curvature radii of each lens are generated as the initial data to meet a condition represented by an inequality.

### BACKGROUND OF THE INVENTION

1. Field of the Invention

The present invention relates to a method of generating initial data to be used to design an optical system, a design method of designing an optical system, a manufacturing method of manufacturing an optical system, and a storage medium.

2. Description of the Related Art

There exists an optical system used in a vacuum environment such as a vacuum chamber or outer space. The optical system to be used in the vacuum environment is generally assembled and adjusted in an atmospheric environment. The imaging position changes between the atmospheric environment and the vacuum environment because the refractive index changes. Japanese Patent Nos. 3335901, 4819419, and 2573535 propose methods of designing an optical system while suppressing a change in the imaging position even when the refractive index changes between an environment where the optical system is adjusted and an environment where it is used.

Japanese Patent No. 3335901 proposes a method of determining the glass material of each lens such that a change in the imaging position of an optical system caused by a change in the atmospheric pressure is canceled between the front lens group and the rear lens group of the optical system. Japanese Patent No. 4819419 proposes a method of using two optical systems in which the imaging positions change in different directions in accordance with an environmental change and causing the two optical systems to cancel the changes in the imaging positions when the environment has changed. Japanese Patent No. 2573535 proposes a method of forming an optical system by three lens groups and determining the refractive power of each lens group such that the amount of a change in the focal length caused by an environmental change falls within a predetermined range.

In Japanese Patent No. 3335901, however, when the glass material of each lens is determined, the refractive power of each lens is determined, too. Hence, the design freedom of the optical system may be constrained in aberration correction to be performed after the determination of the glass materials. In Japanese Patent No. 4819419, since the two optical systems cancel changes in the imaging positions caused by an environmental change, the arrangement may be limited to the two optical systems. In Japanese Patent No. 2573535, when the optical system is designed using conditional expressions described in this related art in association with the focal length, the refractive power of each lens group is determined first. Hence, the design freedom of the optical system may be constrained in aberration correction to be performed after the determination of the refractive powers. For this reason, when these methods are used, it is therefore difficult to design an optical system meeting target performance, or the design load increases.

### SUMMARY OF THE INVENTION

The present invention provides a technique advantageous in designing an optical system whose optical performance changes within an allowable range in accordance with an environmental change.

According to one aspect of the present invention, there is provided a generation method of generating, by a computer, initial data to be used when designing an optical system in which a plurality of lenses are arranged in an optical axis direction, wherein in an optical system model in which a thickness of each lens and intervals between the plurality of lenses are set to 0, letting m be the number of lenses, r₂ᵢ₋₁ and r₂ᵢ be curvature radii of two surfaces of an ith lens, respectively, and I₁ and I₂ be a first index and a second index, respectively, the curvature radii of each lens are generated as the initial data to meet a condition represented by an inequality

$${I}_{1} \leq {\sum }_{i = 1}^{m} ( \frac{1}{{r}_{2 i - 1}} - \frac{1}{{r}_{2 i}} ) \leq {I}_{2} .$$

Further aspects of the present invention will become apparent from the following description of exemplary embodiments with reference to the attached drawings.

### BRIEF DESCRIPTION OF THE DRAWINGS

FIG. 1 is a schematic view showing an optical system according to the first embodiment;

FIG. 2 is a view showing an optical system designed without considering an environmental change;

FIG. 3 is a view showing a lens whose lens thickness is assumed to be 0;

FIG. 4A is a flowchart showing a method of designing an optical system according to the first embodiment;

FIG. 4B is a flowchart showing a method of generating initial data according to the first embodiment;

FIG. 5 is a schematic view showing the arrangement of an exposure apparatus;

FIG. 6 is a schematic view showing the arrangement of a drawing apparatus using an electron beam;

FIG. 7 is a table showing initial data when designing an optical system including five lenses;

FIG. 8A is a flowchart showing a method of designing an optical system according to the second embodiment;

FIG. 8B is a flowchart showing a method of generating initial data according to the second embodiment;

FIG. 9 is a view showing an example of a user interface when determining the curvature radius of each lens;

FIG. 10 is a view showing an example of a user interface when determining the curvature radius of each lens;

FIG. 11 is a flowchart showing a manufacturing method of an optical system;

FIG. 12 is a conceptual view showing a design approach to target performance when designing an optical system; and

FIG. 13 is a block diagram showing the arrangement of a computer.

### DESCRIPTION OF THE EMBODIMENTS

Exemplary embodiments of the present invention will be described below with reference to the accompanying drawings. Note that the same reference numerals denote the same members throughout the drawings, and a repetitive description thereof will not be given.

### First Embodiment

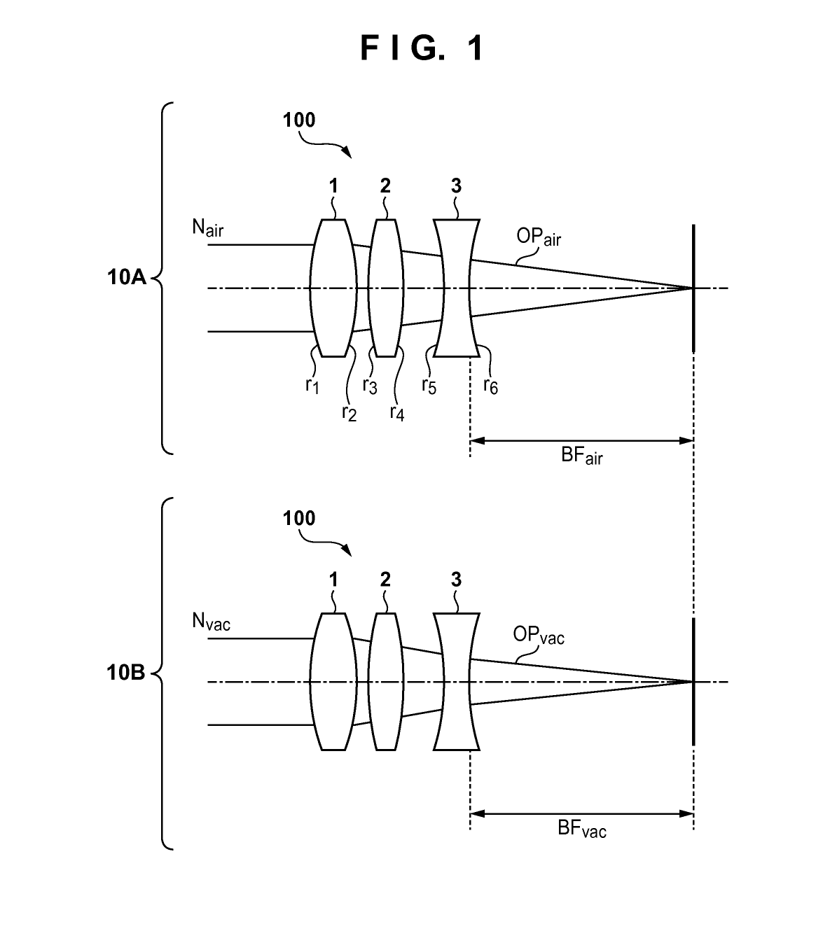

An optical system 100 according to the first embodiment of the present invention will be described with reference to FIG. 1. FIG. 1 is a schematic view showing the optical system 100 according to the first embodiment. The optical system 100 includes, for example, three lenses 1, 2, and 3 arranged along the optical axis direction and condenses parallel light. Each lens includes two surfaces to condense light. In the optical system 100 according to the first embodiment, the curvature radii of the two surfaces of the lens 1 are defined as r₁ and r₂, the curvature radii of the two surfaces of the lens 2 as r₃ and r₄, and the curvature radii of the two surfaces of the lens 3 as r₅ and r₆. Reference numeral 10A in FIG. 1 indicates a case in which the optical system 100 is arranged in an atmospheric environment (an environment to adjust the optical system 100). Reference numeral 10B in FIG. 1 indicates a case in which the optical system 100 is arranged in a vacuum environment (an environment to use the optical system 100). These arrangements are the same except the environment where the optical system 100 is arranged. In 10A and 10B of FIG. 1, the refractive indices in the atmosphere and vacuum are represented by Nₐᵢᵣ and N_{vac}, the light beams are represented by OPₐᵢᵣ and OP_{vac}, and the distances from the rearmost end (surface r₆) of the lens 3 to the focal plane are represented by BFₐᵢᵣ and BF_{vac}. The atmospheric refractive index Nₐᵢᵣ and the vacuum refractive index N_{vac} are 1.00027 and 1.00000, respectively.

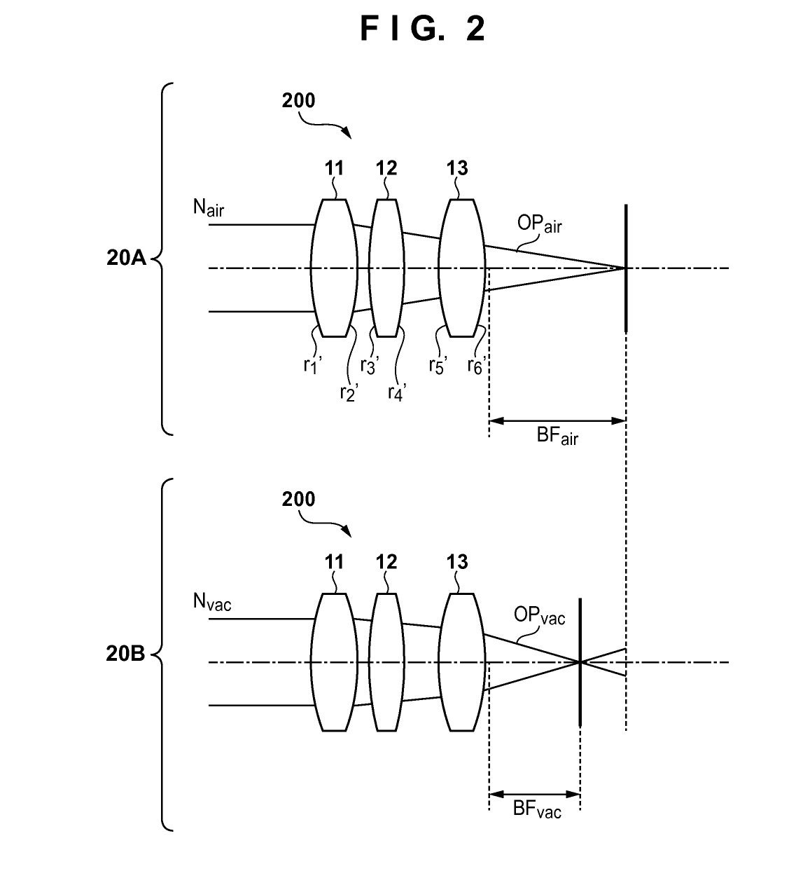

An optical system 200 designed without considering an environmental change between the atmospheric environment and the vacuum environment will be described first with reference to FIG. 2. Reference numerals 20A and 20B in FIG. 2 indicate imaging positions of the optical system 200 in the atmospheric environment and the vacuum environment. The optical system 200 includes three lenses 11, 12, and 13 arranged along the optical axis direction and condenses parallel light, like the optical system 100 of the first embodiment. Each lens includes two surfaces to condense light. In the conventional optical system 200, the curvature radii of the two surfaces of the lens 11 are defined as r₁′ and r₂′, the curvature radii of the two surfaces of the lens 12 as r₃′ and r₄′, and the curvature radii of the two surfaces of the lens 13 as r₅′ and r₆′. The optical system 200 is designed without considering the difference between the environment to adjust the optical system and the environment to use it. For this reason, there is a difference between the angle of refraction of the light beam OPₐᵢᵣ and that of the light beam OP_{vac} because of the difference between the refractive indices (Nₐᵢr and N_{vac}) in the atmosphere and vacuum. If the angles of refraction of the light beams have a difference due to the environmental change, the distances BFₐᵢᵣ and BF_{vac} from the rearmost end (surface r₆′) of the lens 13 to the focal plane have a difference. This means that when the optical system 200 is adjusted in the atmospheric environment and then arranged and used in the vacuum environment, the imaging position changes. The optical system 100 according to the first embodiment is designed such that the imaging position falls within an allowable range even when the refractive index changes between the atmospheric environment where the optical system 100 is adjusted and the vacuum environment where the optical system 100 is used.

The design method of the optical system 100 according to the first embodiment will be described next. In the first embodiment, the curvature radii of the surfaces of each lens are used as initial data to design the optical system 100. Assuming that the thickness (to be referred to as a lens thickness hereinafter) of each lens and the intervals (to be referred to as lens intervals hereinafter) between the plurality of lenses are 0, the curvature radii are determined to meet a condition represented by

$${I}_{1} \leq {\sum }_{i = 1}^{m} ( \frac{1}{{r}_{2 i - 1}} - \frac{1}{{r}_{2 i}} ) \leq {I}_{2} \qquad ( 1 )$$

where m is the number of lenses, r₂ᵢ₋₁ and r₂ᵢ are the curvature radii of the two surfaces of the ith lens, respectively, and I₁ and I₂ are the first index and the second index, respectively. Letting f be the focal length of the optical system 100, and fₘᵢₙ and fₘₐₓ be the lower limit value and the upper limit value of the allowable range of the focal length f, the first index I₁ and the second index I₂ are given by

$${I}_{1} = - \frac{1}{{f}_{min}} , \\ {I}_{2} = - \frac{1}{{f}_{max}} \qquad ( 2 )$$

At this time, inequality (1) is rewritten, based on equations (2), to

$$- \frac{1}{{f}_{min}} \leq {\sum }_{i = 1}^{m} ( \frac{1}{{r}_{2 i - 1}} - \frac{1}{{r}_{2 i}} ) \leq - \frac{1}{{f}_{max}} \qquad ( 3 )$$

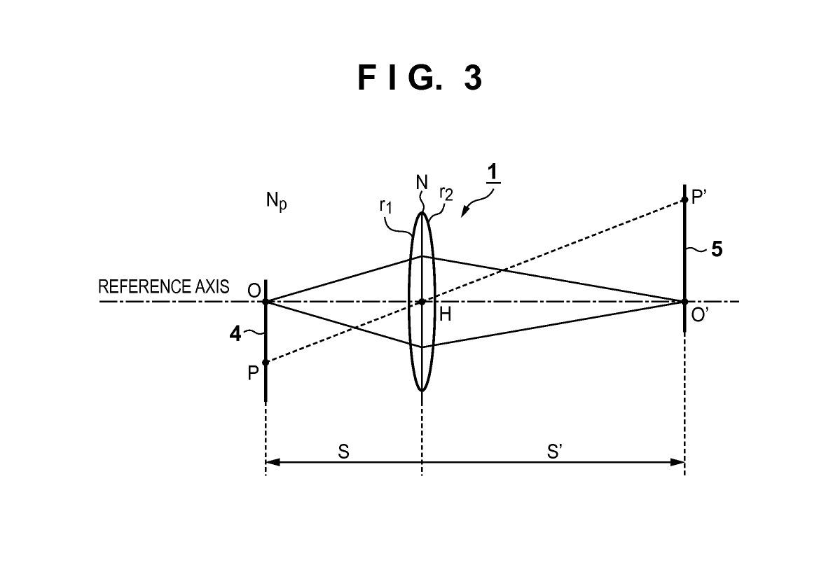

The derivation method of inequality (3) will be described here with reference to FIG. 3. FIG. 3 is a view showing the lens 1 arranged in an environment of a refractive index Nₚ and assumed to have a lens thickness of 0. Referring to FIG. 3, a position H is the position of the lens 1 on the optical axis (reference axis), and positions O and O′ are the positions of an object plane 4 and an image plane 5, respectively. The lens thickness is set to the unrealistic value of 0 because each lens can easily be handled in designing the optical system. For this reason, in the first embodiment, first, an optical system model in which the lens thicknesses and the lens intervals are assumed to be 0 is set. After that, the lens thicknesses and the lens intervals are changed to values other than 0 using the curvature radii of the lenses in the optical system model as initial data. In the lens 1 shown in FIG. 3, let N be the refractive index of the glass material used in the lens 1, and r₁ and r₂ be the curvature radii of the two surfaces of the lens 1. In this case, a paraxial image represented by

$$\frac{{N}_{p}}{{S}^{′}} = \frac{{N}_{p}}{S} + ( N - {N}_{p} ) \cdot ( \frac{1}{{r}_{1}} - \frac{1}{{r}_{2}} ) \qquad ( 4 )$$

geometric-optically holds, where S is the distance from the lens 1 to the object plane 4, and S′ is the distance from the lens 1 to the image plane 5.

Since a relation 1/S′=1/S+1/fₚ holds, a focal length fₚ is given, based on equation (4), by

$$\frac{1}{{f}_{p}} = ( \frac{N}{{N}_{p}} - 1 ) \cdot ( \frac{1}{{r}_{1}} - \frac{1}{{r}_{2 }} ) \qquad ( 5 )$$

Note that the relation 1/S′=1/S+1/fₚ can be confirmed from the fact that in FIG. 3, when the position O of the object plane is at the infinity distance, that is, S→∞, S′=fₚ holds, and when the position O′ of the image plane is at the infinity distance, that is, S′→∞, S=−fₚ holds.

Equation (5) represents the focal length fₚ when the lens 1 having a lens thickness of 0 is formed from a single lens. Hence, in the optical system 100 including a plurality of lenses, the focal length is given, based on equation (5), by

$$\begin{matrix}\frac{1}{{f}_{air}} = {\sum }_{i = 1}^{m} ( \frac{{N}_{i}}{{N}_{air}} - 1 ) \cdot ( \frac{1}{{r}_{if}} - \frac{1}{{r}_{ib}} ) \\ or & ( 6 ) \\ \frac{1}{f} = {\sum }_{i = 1}^{m} ( \frac{{N}_{i}}{{N}_{vac}} - 1 ) \cdot ( \frac{1}{{r}_{if}} - \frac{1}{{r}_{ib}} ) & ( 7 )\end{matrix}$$

Equation (6) represents a focal length fₐᵢᵣ when the optical system 100 is arranged in the atmospheric environment (environment to adjust the optical system 100), and equation (7) represents the focal length f when the optical system 100 is arranged in the vacuum environment (environment to use the optical system 100). In equations (6) and (7), not only the lens thickness of each lens but also the intervals (lens intervals) between the plurality of lenses are also set to 0. In equations (6) and (7), m is the number of lenses, Nₐᵢᵣ is the refractive index in the atmosphere, N_{vac} is the refractive index in the vacuum, and Nᵢ is the refractive index of the glass material used in the ith lens. In addition, r_{if} is the curvature radius of the surface of the ith lens on the side of the object plane 4, and r_{ib} is the curvature radius of the surface of the ith lens on the side of the image plane 5.

The difference between equations (6) and (7) is given by

$$\begin{matrix}\frac{1}{f} - \frac{1}{{f}_{air}} = {\sum }_{i = 1}^{m} ( \frac{{N}_{i}}{{N}_{vac}} - 1 ) \cdot ( \frac{1}{{r}_{if}} - \frac{1}{{r}_{ib}} ) - {\sum }_{i = 1}^{m} ( \frac{{N}_{i}}{{N}_{air}} - 1 ) \cdot ( \frac{1}{{r}_{if}} - \frac{1}{{r}_{ib}} ) \\ = ( \frac{1}{{N}_{vac}} - \frac{1}{{N}_{air}} ) {\sum }_{i = 1}^{m} {N}_{i} ( \frac{1}{{r}_{if}} - \frac{1}{{r}_{ib}} ) \\ = ( \frac{1}{{N}_{vac}} - \frac{1}{{N}_{air}} ) {\sum }_{i = 1}^{m} \{ ( {N}_{i} - 1 ) \cdot ( \frac{1}{{r}_{if}} - \frac{1}{{r}_{ib}} ) + ( \frac{1}{{r}_{if}} - \frac{1}{{r}_{ib}} ) \} \\ = ( \frac{1}{{N}_{vac}} - \frac{1}{{N}_{air}} ) \cdot [ \frac{1}{f} + {\sum }_{i = 1}^{m} ( \frac{1}{{r}_{if}} - \frac{1}{{r}_{ib}} ) ]\end{matrix} \qquad ( 8 )$$

In the optical system model in which the lens thicknesses and the lens intervals are set to 0, when the focal length f in the vacuum environment and the focal length fₐᵢᵣ in the atmospheric environment equal, that is, when equation (8) yields 0, the change in the imaging position caused by the environmental change is 0. Hence, in the optical system model in which the lens thicknesses and the lens intervals are set to 0, the condition of the focal length f under which the change in the imaging position caused by the environmental change is 0 is represented, based on equation (8), by

$$- \frac{1}{f} = {\sum }_{i = 1}^{m} ( \frac{1}{{r}_{if}} - \frac{1}{{r}_{ib}} ) \qquad ( 9 )$$

In actuality, the change in the imaging position caused by the environmental change need only fall within a desired allowable range. For this reason, when the allowable range of the focal length f is set, and the lower limit value and the upper limit value of the allowable range are set as fₘᵢₙ and fₘₐₓ, respectively, inequality (3) is derived and rewritten as

$$- \frac{1}{{f}_{min}} \leq \frac{1}{{r}_{1}} - \frac{1}{{r}_{2}} + … + \frac{1}{{r}_{2 m - 1}} - \frac{1}{{r}_{2 m}} \leq - \frac{1}{{f}_{max}} \qquad ( 10 )$$

Letting X be the allowable ratio of the change (allowable change ratio) of the focal length f, the first index I₁ and the second index I₂ of inequality (1) are given by

$$\begin{matrix}{I}_{1} = \frac{1}{( 1 - X ) \times f} , & {I}_{2} = \frac{I}{( 1 + X ) \times f}\end{matrix} \qquad ( 11 )$$

When the first index I₁ and the second index I₂ are expressed in this way, inequality (1) can be rewritten as

$$- \frac{1}{( 1 - X ) \times f} \leq \frac{1}{{r}_{1}} - \frac{1}{{r}_{2}} + … + \frac{1}{{r}_{2 m - 1}} - \frac{1}{{r}_{2 m}} \leq - \frac{1}{( 1 + X ) \times f} \qquad ( 12 )$$

The allowable change ratio X is set to, for example, 1%, 0.1%, or 0.01%. This can suppress the change in the imaging position caused by the environmental change in the optical system model in which the lens thicknesses and the lens intervals are set to 0 to 1% or less, 0.1% or less, or 0.01% or less of the focal length f. When the allowable change ratio X of the focal length f is set to 1%, inequality (12) can be rewritten as

$$- \frac{1}{0.99 \times f} \leq \frac{1}{{r}_{1}} - \frac{1}{{r}_{2}} + … + \frac{1}{{r}_{2 m - 1}} - \frac{1}{{r}_{2 m}} \leq - \frac{1}{1.01 \times f} \qquad ( 13 )$$

The design method of the optical system 100 according to the first embodiment will be described. To design an optical system, a computer is used in general, and setting initial data at the start of design is very important. This is because the speed of calculation convergence in the computer and the time needed for the design change depending on how to set the initial data. Especially, in the optical system 100 designed to suppress the change in the imaging position caused by the environmental change, the constraint conditions in the design are stricter than in a general optical system. For this reason, if the initial data setting is not appropriate, calculation does not converge in the computer, or the calculation time becomes long.

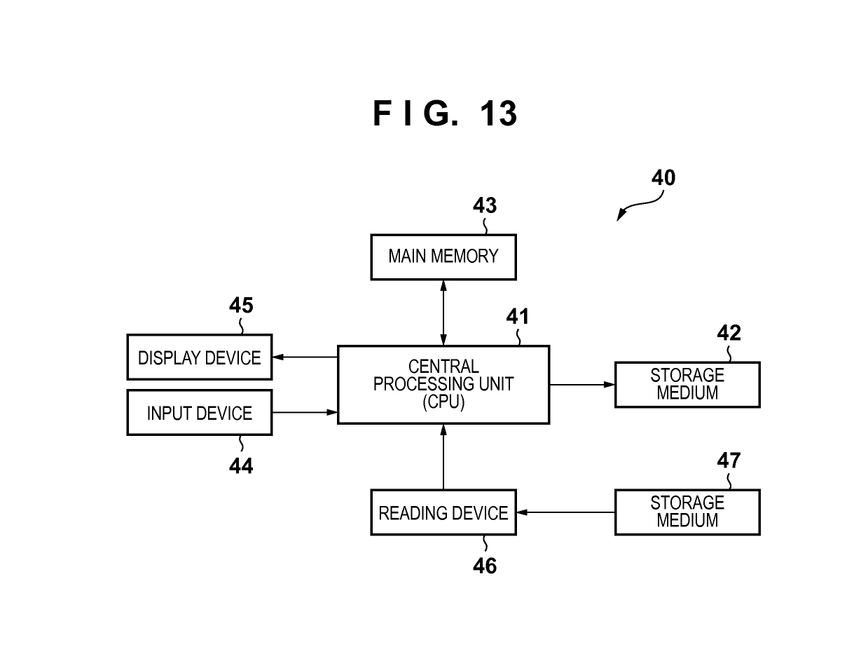

For example, FIG. 13 shows an example of the computer. A computer 40 includes a central processing unit (CPU) 41, a storage medium 42 such as a hard disk to store programs and data, and a main memory 43. The computer 40 also includes an input device 44 such as a keyboard or a mouse, a display device 45 such as a liquid crystal display, and a reading device 46 that reads out a program from a storage medium 47 such as a CD-ROM or a DVD-ROM. The storage medium 42, the main memory 43, the input device 44, the display device 45, and the reading device 46 are connected to the central processing unit 41. In the computer 40, the storage medium 47 storing a program of an optical system design method to be described later is loaded in the reading device 46, and the reading device 46 reads out the program from the storage medium 47. The program read out by the reading device 46 is installed in the storage medium 42. The program installed in the storage medium 42 is executed by the central processing unit 41. The computer 40 thus executes calculation to design the optical system that suppresses the change in the imaging position caused by the environmental change.

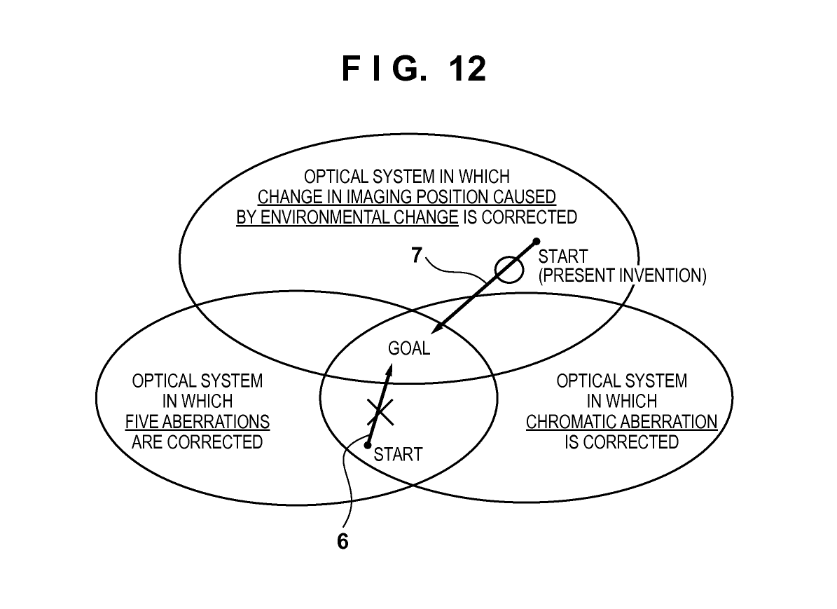

Problems that arise upon setting the initial data will be described here with reference to FIG. 12. FIG. 12 is a conceptual view showing a design approach to target performance when designing the optical system 100 according to the first embodiment. When designing a general optical system, Seidel's five aberrations and a chromatic aberration are only corrected. In the optical system 100 according to the first embodiment, however, a change in optical performance, for example, a change in the imaging position caused by an environmental change also needs to be suppressed. Hence, the goal, that is, target performance when designing the optical system 100 of the first embodiment is located at the portion where the three regions overlap. For example, assume a case in which data obtained by correcting the Seidel's five aberrations and the chromatic aberration are used as initial data, as in the conventional optical system design method, and the change in the imaging position caused by the environmental change is corrected based on the initial data (corresponding to an arrow 6 in FIG. 12). In this case, the initial data are obtained without considering the change in the environment to arrange the optical system, and the change in the imaging position caused by the environmental change needs to be corrected by adding a new constraint condition in the design. As the constraint condition, for example, a condition under which the difference between the distance BFₐᵢᵣ in the atmospheric environment to adjust the optical system and the distance BF_{vac} in the vacuum environment to use the optical system shown in FIG. 2 becomes equal to or less than an allowable value is usable. However, when the optical system is designed by adding such a constraint condition, optimization is performed locally within a narrow range near the initial data. Hence, it may be difficult to design the optical system meeting the constraint condition. To prevent this, a method of designing the optical system based on an enormous number of initial data or a method of repetitively performing optimization while changing the constraint condition is necessary. Hence, reaching the goal (target performance) shown in FIG. 12 is impossible or takes a considerable time. On the other hand, in the design method of the optical system 100 according to the first embodiment, the initial data are set to meet inequality (1). That is, the initial data are set to suppress the change in the imaging position caused by the environmental change. The optical system in which the Seidel's five aberrations and the chromatic aberration are corrected is designed based on the initial data (corresponding to an arrow 7 in FIG. 12). Designing the optical system by this approach makes it possible to easily reach the goal (target performance) shown in FIG. 12 without increasing the design load, as compared to the conventional design method.

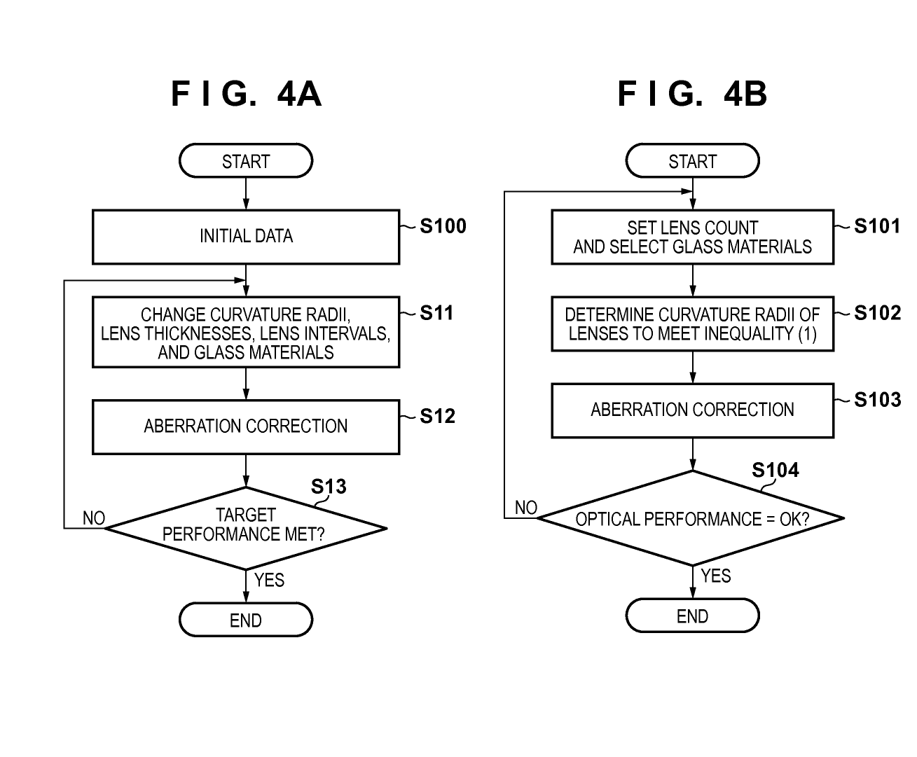

The design method of the optical system 100 according to the first embodiment using the design approach indicated by the arrow 7 in FIG. 12 will be described with reference to FIGS. 4A and 4B. FIGS. 4A and 4B are flowcharts showing a method of causing the computer 40 to design the optical system 100 based on a program installed in the storage medium 42. FIG. 4A is a flowchart showing a method of causing the computer 40 to design the optical system 100 based on initial data. In step S100, the computer 40 generates initial data based on steps S101 to S104 shown in FIG. 4B. A method of causing the computer 40 to generate initial data will be explained here with reference to FIG. 4B. FIG. 4B is a flowchart showing the method of causing the computer 40 to generate initial data.

In step S101, the central processing unit 41 of the computer 40 sets the number of lenses (to be referred to as a lens count hereinafter) to be included in the optical system 100, and selects the glass material of each lens. To reduce the change in the imaging position caused by the environmental change, the optical system 100 needs to include two or more lenses. Hence, the lens count is set in consideration of the performance, cost, arrangement space, and the like required for the optical system 100. The glass material of each lens is selected such that occurrence of the chromatic aberration is suppressed by combining high-variance glass materials and low-variance glass materials. For example, the storage medium 42 shown in FIG. 13 stores a table representing the relationship between the lens count and the glass materials of the lenses. The central processing unit 41 sets the lens count based on the performance, cost, arrangement space, and the like required for the optical system 100 which are input via the input device 44. The central processing unit 41 then selects the glass material of each lens from the table stored in the storage medium 42 such that occurrence of the chromatic aberration is suppressed in the set lens count. In step S102, the central processing unit 41 of the computer 40 determines the curvature radii of each lens based on the lens count and the glass materials of the lenses set and selected in step S101 to meet, for example, inequality (12) in which the allowable change ratio X is set. The lens count, the glass materials of the lenses, and the curvature radii of the lenses are thus determined in the optical system model in which the lens thicknesses and the lens intervals are set to 0. In step S103, the central processing unit 41 corrects the Seidel's five aberrations and the chromatic aberration in the optical system model in which the glass materials and the curvature radii of the lenses are set in step S102 while keeping the condition of inequality (12). The combination of the curvature radii and glass materials of the lenses, which optimizes the aberration performance, is thus determined. Note that the central processing unit 41 may simultaneously execute steps S102 and S103 to determine the combination of the curvature radii and glass materials of the lenses. In step S104, the central processing unit 41 judges whether the combination of the curvature radii and glass materials of the lenses determined in step S103 meets desired optical performance (allowable condition) concerning the Seidel's five aberrations, the chromatic aberration, and the change in the imaging position caused by the environmental change. If the determined combination meets the desired optical performance, the central processing unit 41 determines the combination of the curvature radii and glass materials of the lenses as initial data. On the other hand, if the desired optical performance is not met, the process returns to step S101. The optical performance includes, for example, the Seidel's five aberrations, the chromatic aberration, and the change in the imaging position caused by the environmental change, and may additionally include the effective diameters and focal lengths of the lenses.

In step S11, the central processing unit 41 of the computer 40 changes the lens thicknesses, the lens intervals, and the curvature radii and glass materials of the lenses based on the initial data determined in step S100. Especially, since the initial data are determined in the optical system model in which the lens thicknesses and the lens intervals are set to 0, changing the lens thicknesses and the lens intervals is indispensable when designing the actual optical system. In the design method according to the first embodiment, the central processing unit 41 repeats the step of slightly increasing the lens thicknesses and the lens intervals in step S11 and the step of performing aberration correction in step S12 to be described later, thereby performing calculation to make the optical performance of the optical system 100 gradually close to the target performance. For example, when the increment of the lens thickness and the lens interval is set to 0.5 mm or less, and the lens thicknesses and the lens intervals are gradually increased from 0, aberration correction can be performed in consideration of the change in the imaging position caused by the change in the lens thicknesses and the lens intervals, as compared to a case in which they are increased at once from 0. This makes it possible to prevent the optical performance of the optical system 100 from failing in meeting the target performance or the time consumed to calculate the design from increasing. The method of simultaneously gradually increasing the lens thicknesses and the lens intervals has been described above. However, the present invention is not limited to this. For example, the optical performance of the optical system 100 may be made close to the target performance by gradually increasing the lens thicknesses after gradually increasing the lens intervals. Reversely, the optical performance of the optical system 100 may be made close to the target performance by gradually increasing the lens intervals after gradually increasing the lens thicknesses.

In step S12, the central processing unit 41 corrects the Seidel's five aberrations and the chromatic aberration while keeping the relationship under which the difference in the distance from the rearmost end of the lens to the focal plane between the atmospheric environment and the vacuum environment (the difference between the distance BFₐᵢᵣ and the distance BF_{vac} shown in FIG. 1) becomes equal to or less than the allowable value. Inequality (12) holds in the optical system model in which the lens thicknesses and the lens intervals are set to 0 but does not hold when the lens thicknesses and the lens intervals have values other than 0. For this reason, the central processing unit 41 performs aberration correction in step S12 not to keep the condition of inequality (12) but to keep, for example, the relationship under which the difference in the distance from the rearmost end of the lens to the focal plane between the atmospheric environment and the vacuum environment becomes equal to or less than the allowable value.

In step S13, the central processing unit 41 judges whether the optical performance of the optical system 100 designed in the process up to step S12 meets the target performance. The target performance includes optical performance such as the Seidel's five aberrations, the chromatic aberration, and the change in the imaging position caused by the environmental change, and may additionally include a condition that the lenses of the optical system have lens thicknesses and lens intervals that can actually be manufactured and adjusted. If the optical performance of the optical system 100 meets the target performance, the central processing unit 41 sets the lens thicknesses, the lens intervals, and the like determined up to step S12 as the design values of the optical system 100, and ends the program. On the other hand, if the optical performance of the optical system 100 does not meet the target performance, the process returns to step S11.

As for the method of designing the optical system to suppress the change in the imaging position caused by the environmental change, the difference between the conventional design method and the design method according to the first embodiment will be described. There are conventionally proposed, for example, a first method (Japanese Patent No. 3335901) of designing an optical system after determining the glass materials of lenses and a second method (Japanese Patent No. 2573535) of designing an optical system based on the relationship between the refractive powers and the focal lengths of lens groups included in the optical system. In the first method, the glass materials of the lenses are determined such that a change in the imaging position of the optical system caused by a change in the atmospheric pressure is canceled between the front lens group and the rear lens group of the optical system. In the first method, when the glass material of each lens is determined, the refractive power of each lens is determined, too. Hence, the design freedom of the optical system may be constrained in aberration correction to be performed after the determination of the glass materials. It may therefore be difficult to sufficiently perform aberration correction while suppressing the change in the focal length caused by the environmental change. In the second method, the optical system is formed by a plurality of lens groups, and the refractive power of each lens group is set such that the amount of a change in the focal length caused by an environmental change falls within a predetermined range. In the second method, since the refractive power of each lens group is determined first, the design freedom of the optical system is constrained in aberration correction to be performed after the determination of the refractive powers. It may therefore be difficult to sufficiently perform aberration correction while suppressing the change in the focal length caused by the environmental change, as in the first method. In both the first and second methods, it is necessary to calculate the refractive power of each lens and calculate a synthetic refractive power by synthesizing the refractive powers of the lenses. Hence, as the number of lenses included in the optical system increases, the design load tends to increase. To the contrary, in the design method of the optical system according to the first embodiment, the initial data are determined based on inequality (1), and the optical system is designed based on the determined initial data so as to suppress the change in the imaging position caused by the environmental change. Inequality (1) includes the focal length and the curvature radii of each lens in the optical system model in which the lens thicknesses and the lens intervals are assumed to be 0, and does not individually determine the refractive powers of the lenses included in the optical system. For this reason, the constraint on the design freedom of the optical system is smaller than in the conventional design methods. Additionally, the number of lenses is predetermined, and inequality (1) is applied to an optical system including the predetermined number of lenses. For this reason, the number of lenses does not increase after application of inequality (1). It is therefore possible to avoid an increase in the design load caused by an increase in the lens count.

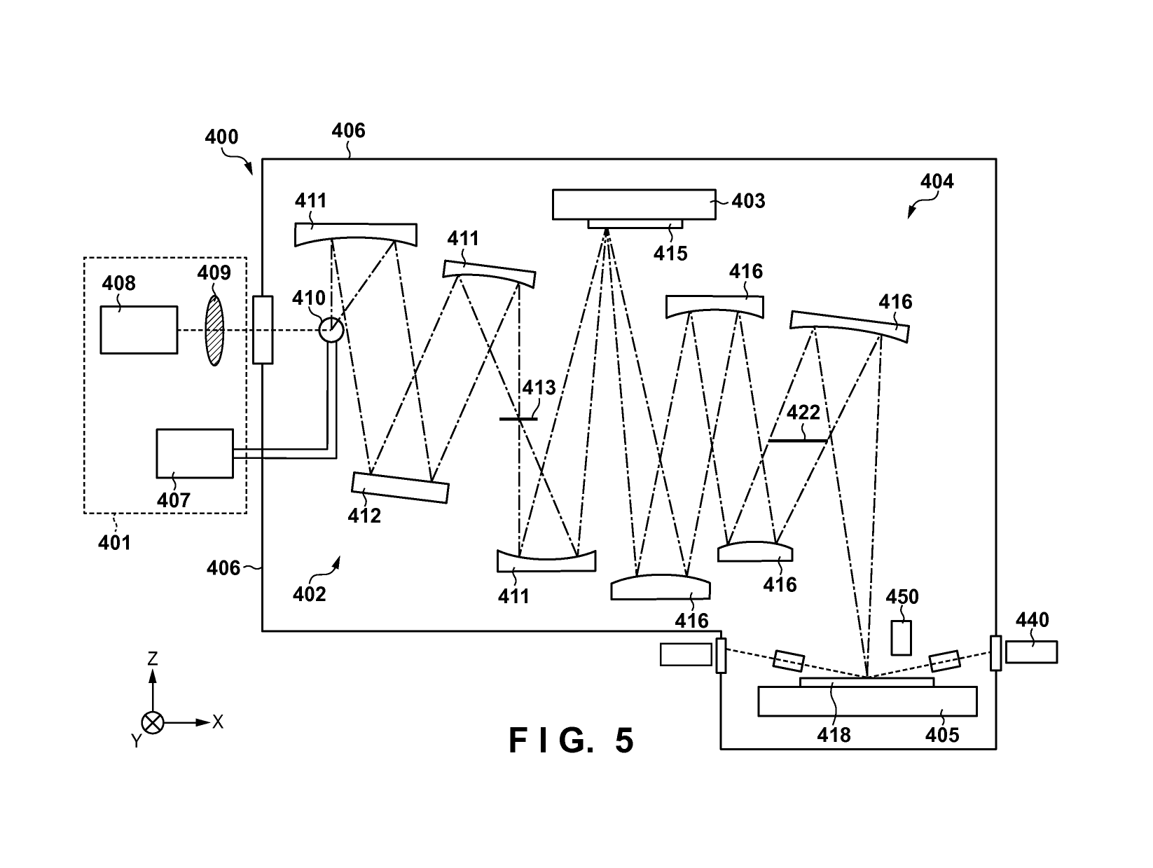

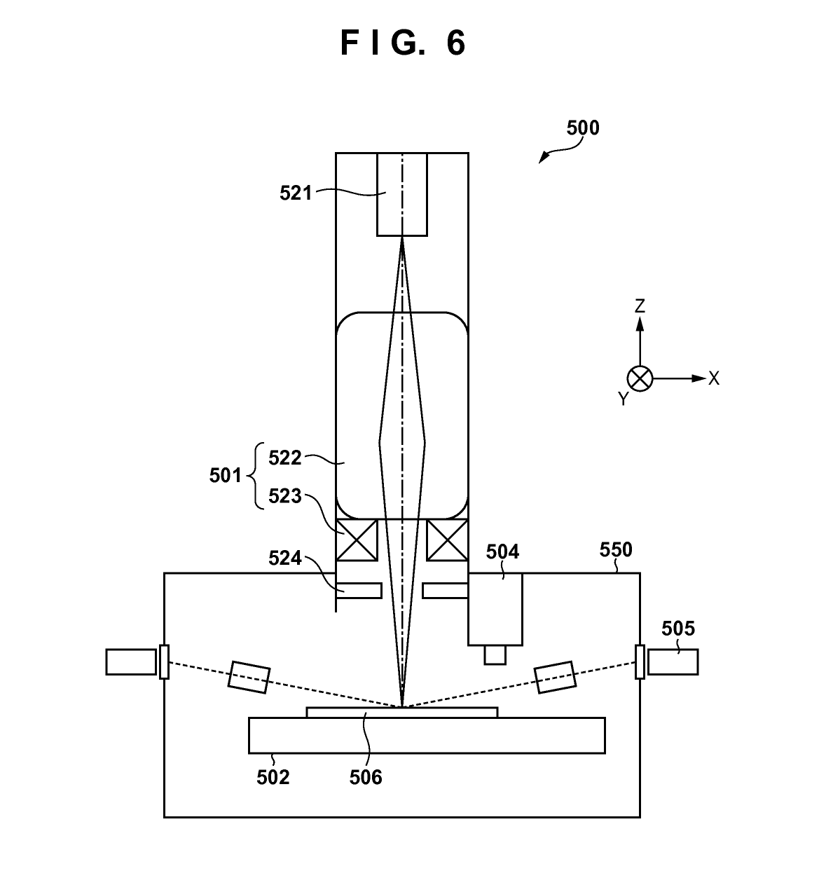

The thus designed optical system 100 is applied to, for example, an alignment detection device or a focus detection device included in an exposure apparatus or a drawing apparatus. An exposure apparatus and an electron beam drawing apparatus including an alignment detection device or a focus detection device with the optical system 100 will be described with reference to FIGS. 5 and 6, respectively. Referring to FIGS. 5 and 6, directions perpendicular to each other on a board surface will be defined as an X direction and a Y direction, and a direction perpendicular to the board surface will be defined as a Z direction.

FIG. 5 is a schematic view showing the arrangement of an exposure apparatus 400. The exposure apparatus 400 includes, for example, a light emitting unit 401, an illumination optical system 402, a reticle stage 403, a projection optical system 404, a wafer stage 405, and a vacuum chamber 406 that covers them. As the light emitting unit 401, for example, a laser plasma light source is used. The light emitting unit 401 includes a supply unit 407 that supplies a target material such as a gas into the vacuum chamber, and an irradiation unit 408 that irradiates the target material with a pulse laser. When the irradiation unit 408 irradiates the target material supplied into the vacuum chamber by the supply unit 407 with the pulse laser via a condenser lens 409, the target material changes to an excited state to generate a high-temperature plasma 410. The plasma 410 can emit EUV light having a wavelength of, for example, about 13 nm. Note that the pressure in the vacuum chamber 406 is kept at 10⁻⁴ to 10⁻⁵ Pa. The illumination optical system 402 includes a plurality of mirrors 411 (multi-layer mirrors or oblique incidence mirrors), an optical integrator 412, and an aperture 413. The emitted EUV light is condensed and irradiates a reticle 415 held on the reticle stage 403. The projection optical system 404 includes a plurality of mirrors 416 and an aperture 422. The EUV light reflected by the reticle 415 irradiates a wafer 418 held on the wafer stage 405. The exposure apparatus 400 includes an alignment detection device 450 to align the pattern of the wafer 418 and the pattern of the reticle 415 in the X and Y directions or align a plurality of shot regions formed on the wafer 418 in the X and Y directions. The exposure apparatus 400 also includes a focus detection device 440 to align the upper surface of the wafer 418 in the Z direction. Each of the alignment detection device 450 and the focus detection device 440 includes the optical system 100 designed by the design method of the first embodiment. This makes it possible to accurately align the wafer 418 in the X and Y directions and in the Z direction even when the environment to adjust the optical system 100 and the environment to use it are different, or the pressure in the vacuum chamber 406 has changed.

FIG. 6 is a schematic view showing the arrangement of a drawing apparatus 500 using an electron beam. The drawing apparatus 500 includes, for example, an electron gun 521, an electron optical system 501, an electron detection system 524, a wafer stage 502, and a vacuum chamber 550 that covers them. The electron gun 521 emits electrons. The electron optical system 501 includes, for example, an electron lens system 522 that converges an electron beam emitted by the electron gun 521, and a deflector 523 that deflects the electron beam. The electron optical system 501 irradiates a target position of a wafer 506 held on the wafer stage 502 with the electron beam. The electron detection system 524 detects the dose of electrons that have passed through the electron optical system 501. The drawing apparatus 500 includes an alignment detection device 504 that detects the X- and Y-direction position of the wafer 506 to irradiate the target position on the wafer 506 with the electron beam. The drawing apparatus 500 also includes a focus detection device 505 that detects the Z-direction position of the upper surface of the wafer 506. Each of the alignment detection device 504 and the focus detection device 505 uses the optical system 100 designed by the design method of the first embodiment. This makes it possible to accurately align the wafer 506 in the X and Y directions and in the Z direction even when the environment to adjust the optical system 100 and the environment to use it are different, or the pressure in the vacuum chamber 550 has changed.

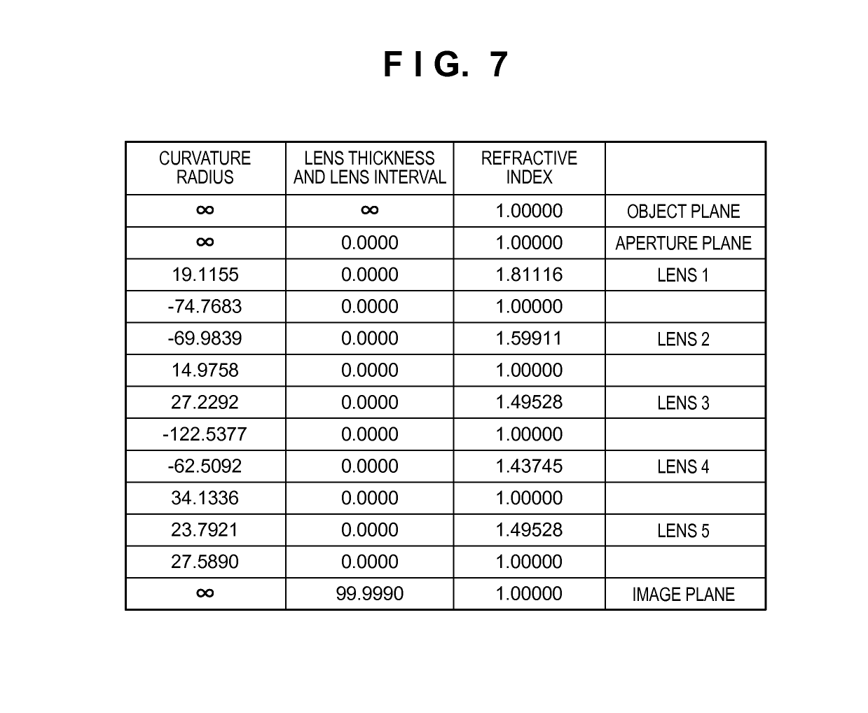

As described above, in the design method of the optical system 100 according to the first embodiment, the computer 40 determines the initial data (the curvature radii of the lenses) to meet the condition of inequality (1) in the optical system model in which the lens thicknesses and the lens intervals are set to 0. Based on the initial data, the computer 40 designs the optical system 100 in which the Seidel's five aberrations and the chromatic aberration are corrected. It is therefore possible to design the optical system 100 in which the Seidel's five aberrations and the chromatic aberration are corrected, and the change in the imaging position caused by the environmental change is suppressed without increasing the calculation load of the computer 40 in designing the optical system 100. In the first embodiment, the optical system 100 to be adjusted in the atmospheric environment and used in the vacuum environment has been described. However, this embodiment is applicable not only to the case in which the environment to adjust the optical system 100 and the environment to use it are the atmospheric environment and the vacuum environment, respectively, but also to a case in which the refractive index changes in the environment where the optical system 100 is arranged. This is because inequality (1) does not depend on the refractive index of the environment to arrange the optical system 100. Examples of the environment to arrange the optical system 100 are a high-pressure environment and a gas atmosphere in addition to the vacuum environment. In the design method according to the first embodiment, the optical system 100 including three lenses has been described. However, the present invention is not limited to this, and the design method is applicable to any optical system including two or more lenses. FIG. 7 shows initial data when designing an optical system including, for example, five lenses using the design method of the first embodiment. The initial data shown in FIG. 7 is generated by causing the central processing unit 41 to perform aberration correction such that the on-axis chromatic aberration coefficient and the magnification chromatic aberration coefficient become 0 in a case in which the center wavelength is 650 nm, the numerical aperture is 0.05, and the focal length is 100 mm.

### Second Embodiment

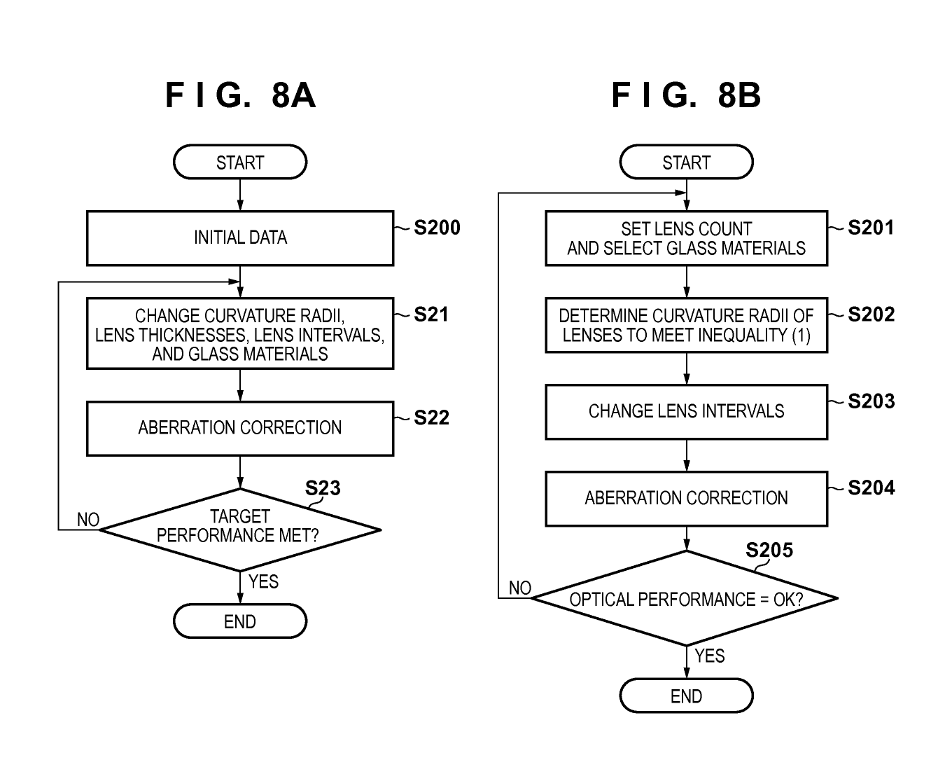

A design method of an optical system according to the second embodiment of the present invention will be described with reference to FIGS. 8A and 8B. FIGS. 8A and 8B are flowcharts showing a method of causing a computer 40 to design the optical system based on a program installed in a storage medium 42. In the design method according to the second embodiment, when generating initial data, the lens intervals are determined after the curvature radii of lenses are determined to meet inequality (1), as compared to the design method of the first embodiment. FIG. 8A is a flowchart showing a method of causing the computer 40 to design the optical system based on initial data. In step S200, the computer 40 generates initial data based on steps S201 to S205 shown in FIG. 8B. A method of causing the computer 40 to generate initial data will be explained here with reference to FIG. 8B. FIG. 8B is a flowchart showing the method of causing the computer 40 to generate initial data.

In step S201, a central processing unit 41 of the computer 40 sets the number of lenses (to be referred to as a lens count hereinafter) to be included in an optical system 100, and selects the glass material of each lens. Step S201 is the same as step S101 of FIG. 4B, and a description thereof will be omitted. In step S202, the central processing unit 41 determines the curvature radii of each lens based on the lens count and the glass materials of the lenses set and selected in step S201 to meet, for example, inequality (12) in which an allowable change ratio X is set. The lens count, the glass materials of the lenses, and the curvature radii of the lenses are thus determined in the optical system model in which the lens thicknesses and the lens intervals are set to 0. In step S203, the central processing unit 41 changes the lens intervals in the optical system model in which the glass materials and curvature radii of the lenses are determined in step S202. Inequality (12) holds in a state in which the lens thicknesses and the lens intervals are set to 0 but does not hold in a state in which the lens thicknesses and the lens intervals are set to values other than 0. For this reason, in step S203, for example, the central processing unit 41 changes the lens intervals to keep the relationship under which the difference in the distance from the rearmost end of the lens to the focal plane between the atmospheric environment and the vacuum environment (the difference between a distance BFₐᵢᵣ and a distance BF_{vac} shown in FIG. 1) becomes equal to or less than an allowable value.

In step S204, the central processing unit 41 corrects the Seidel's five aberrations and the chromatic aberration to keep the relationship under which the difference in the distance from the rearmost end of the lens to the focal plane between the atmospheric environment and the vacuum environment becomes equal to or less than the allowable value. The combination of the lens intervals and the curvature radii and glass materials of the lenses, which optimizes the aberration performance, is thus determined. In step S205, the central processing unit 41 judges whether the combination determined in step S204 meets desired optical performance (allowable condition) concerning the Seidel's five aberrations, the chromatic aberration, and a change in the imaging position caused by an environmental change. If the determined combination of the lens intervals and the curvature radii and glass materials of the lenses meets the desired optical performance, the central processing unit 41 determines the combination as initial data. On the other hand, if the desired optical performance is not met, the process returns to step S201. The optical performance includes, for example, the Seidel's five aberrations, the chromatic aberration, and the change in the imaging position caused by the environmental change, and may additionally include the effective diameters and focal lengths of the lenses.

In step S21, the central processing unit 41 changes the lens thicknesses, the lens intervals, and the curvature radii and glass materials of the lenses based on the initial data determined in step S200. Especially, since the initial data are determined in the optical system model in which the lens thicknesses are set to 0, changing the lens thicknesses is indispensable when designing the actual optical system. When changing the lens thicknesses, the central processing unit 41 repeats the step of slightly increasing the lens thicknesses in step S21 and the step of performing aberration correction in step S22 to be described later, thereby performing calculation to make the optical performance of the optical system gradually close to the target performance, as in step S11 of FIG. 4A. In step S22, the central processing unit 41 corrects the Seidel's five aberrations and the chromatic aberration while keeping the relationship under which the difference in the distance from the rearmost end of the lens to the focal plane between the atmospheric environment and the vacuum environment becomes equal to or less than the allowable value. In step S23, the central processing unit 41 judges whether the optical performance of the optical system designed in the process up to step S22 meets the target performance. The target performance includes optical performance such as the Seidel's five aberrations, the chromatic aberration, and the change in the imaging position caused by the environmental change, and may additionally include a condition that the lenses of the optical system have lens thicknesses and lens intervals that can actually be manufactured and adjusted. If the optical performance of the optical system meets the target performance, the central processing unit 41 sets the lens thicknesses, the lens intervals, and the like determined up to step S22 as the design values of the optical system, and ends the program. On the other hand, if the optical performance of the optical system does not meet the target performance, the process returns to step S21.

The difference between the design method of the first embodiment and that of the second embodiment will be described here. In the design method according to the first embodiment, both the lens thicknesses and the lens intervals are set to 0 in the initial data. In the design method according to the second embodiment, however, only the lens thicknesses are set to 0 in the initial data. That is, handling of the lens thicknesses in the initial data changes between the first embodiment and the second embodiment. In the design method according to the first embodiment, since the lens intervals in the initial data are 0, the computer 40 needs to increase the lens interval change amount in step S11 of FIG. 4A. In general, when the lens interval change amount is large, the change in the refractive power of the optical system is larger than in a case in which the lens interval change amount is small. For this reason, when the lens intervals are changed largely, the refractive power of the optical system after the change of the lens intervals largely changes from the refractive power in the initial data. As a result, it may be impossible to meet the target performance of the optical system because of an increase in the change in the imaging position caused by the environmental change or degradation in the aberration performance. On the other hand, the design method according to the second embodiment uses initial data in which the lens intervals have been changed in step S203 of FIG. 8B. For this reason, when the computer 40 changes the lens intervals in step S21 of FIG. 8A, the lens interval change amount can be made smaller than in the design method of the first embodiment. This can suppress the refractive power of the optical system in which the lens intervals have been changed from largely changing from the refractive power in the initial data and facilitate design of the optical system meeting the target performance. Additionally, in the second embodiment, when causing the computer 40 to determine the initial data in step S200 of FIG. 8A, aberration correction is performed by changing the lens intervals without considering the influence of the lens thicknesses (step S204 of FIG. 8B). This makes it possible to facilitate aberration correction in step S22 of FIG. 8A as compared to aberration correction in step S12 of the first embodiment.

As described above, in the design method of the optical system according to the second embodiment, the computer 40 determines the curvature radii of the lenses to meet the condition of inequality (1) in the optical system model in which the lens thicknesses and the lens intervals are set to 0. After determining the curvature radii of the lenses, the computer 40 changes the lens intervals and performs aberration correction, thereby determining the initial data. Based on the initial data, the computer 40 designs the optical system in which the Seidel's five aberrations and the chromatic aberration are corrected. It is therefore possible to design the optical system in which the Seidel's five aberrations and the chromatic aberration are corrected, and the change in the imaging position caused by the environmental change is suppressed without increasing the calculation load of the computer 40 in designing the optical system.

### Third Embodiment

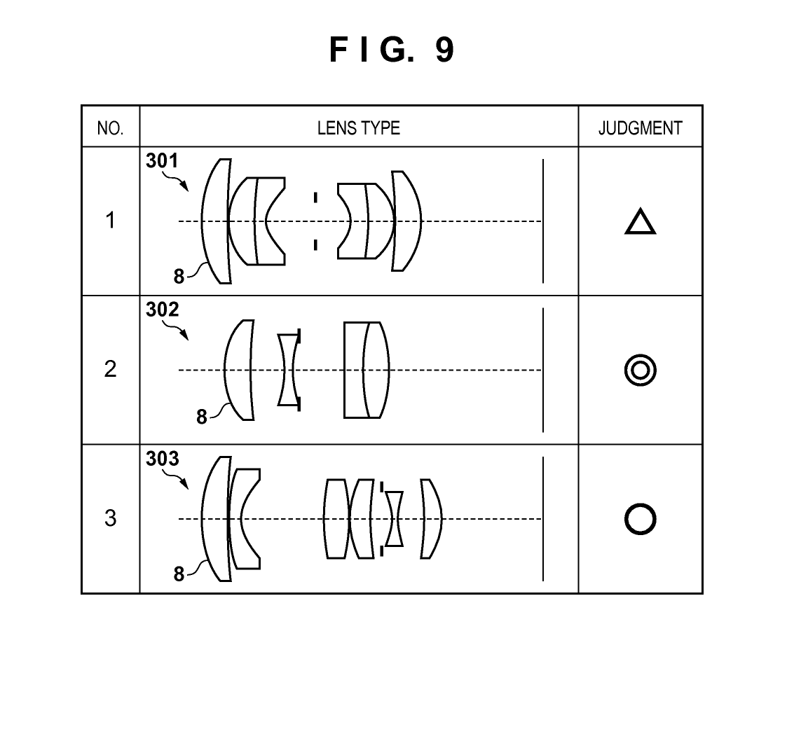

In the third embodiment of the present invention, an example will be described with reference to FIG. 9, in which a computer 40 determines initial data (the curvature radii of lenses) to meet the condition of inequality (1) in an optical system model in which the lens thicknesses and the lens intervals are set to 0. In the third embodiment, the computer 40 derives a result of judging for each lens type (optical system model) whether designing an optical system capable of suppressing a change in the imaging position caused by an environmental change is easy (difficulty).

FIG. 9 is a view showing a result obtained by causing the computer 40 to judge for three lens types whether designing an optical system capable of suppressing a change in the imaging position caused by an environmental change is easy (difficulty). FIG. 9 shows lens types 301 to 303 each including a plurality of lenses 8. The difficulty in designing the optical system is represented by ⊚, ◯, or Δ for each lens type. Referring to FIG. 9, the lens types 301 to 303 are optical system models in which the lens thicknesses the lens intervals of the lenses 8 are set to 0. ⊚ indicates that designing the optical system is easiest, ◯ indicates that designing the optical system is easy, and Δ indicates that designing the optical system is difficult. As for the lens types 301 to 303 shown in FIG. 9, for example, a storage medium 42 stores the information of the plurality of lens types. A central processing unit 41 selects one of the plurality of lens types in consideration of the performance, cost, and arrangement space required for the optical system. The central processing unit 41 substitutes information about a lens count m, a focal length f, and a curvature radii r and refractive index N of each lens 8 into inequality (1) for each of the three lens types 301 to 303. The central processing unit 41 calculates inequality (1) based on these pieces of information to judge whether the lens types 301 to 303 can easily design the optical system capable of suppressing the change in the imaging position caused by the environmental change. In FIG. 9, the lens type 302 of No. 2 is “⊚”, and the lens type 303 of No. 3 is “◯”. For this reason, the central processing unit 41 designs the optical system in accordance with the flowcharts of FIGS. 4A and 4B or the flowcharts of FIGS. 8A and 8B for the lens type 302 or 303.

### Fourth Embodiment

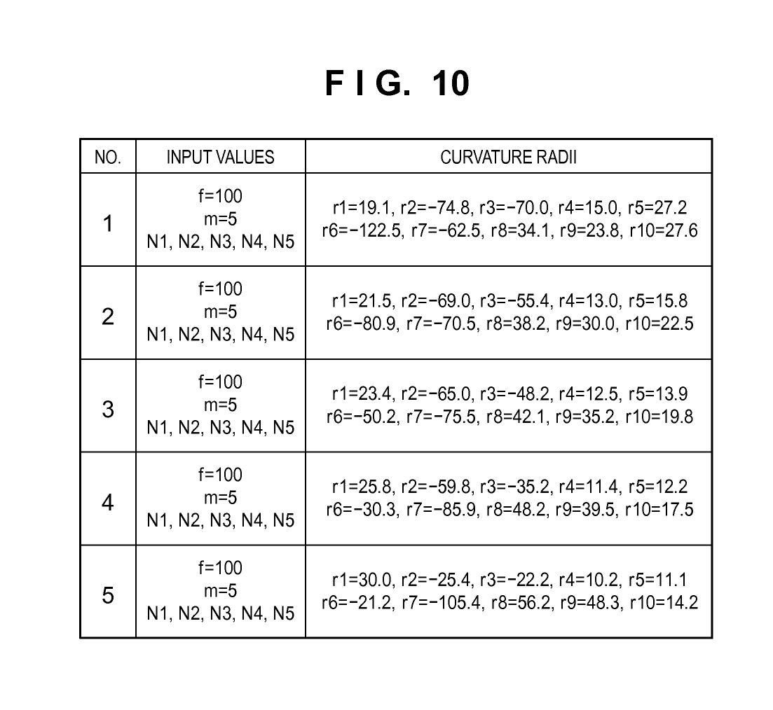

In the fourth embodiment of the present invention, an example will be described with reference to FIG. 10, in which a computer 40 determines initial data (the curvature radii of lenses) to meet the condition of inequality (1) in an optical system model in which the lens thicknesses and the lens intervals are set to 0. In the fourth embodiment, the computer 40 determines a plurality of candidates of initial data (the curvature radii of lenses) of an optical system for the respective parameters (lens count, focal length, refractive index, and the like) in an optical system model in which the lens thicknesses and the lens intervals are set to 0. The computer 40 selects, from the plurality of determined initial data candidates, initial data optimum for designing an optical system capable of suppressing a change in the imaging position caused by an environmental change.

FIG. 10 is a view showing a result obtained by causing a central processing unit 41 of the computer 40 to output initial data (curvature radii r of lenses) meeting inequality (1) via a display device 45 based on a focal length f, a lens count m, and refractive indices N1 to N5. In the fourth embodiment, optical specifications such as the focal length f, the lens count m, and the refractive indices N of the lenses of the optical system are input to the central processing unit 41 via an input device 44 based on constraints such as the cost of the optical system and the space to set the lenses. Referring to FIG. 10, the focal length f is set to 100 mm, the lens count is set to 5, and the refractive indices of the five lenses are set to N1 to N5, respectively. Based on the input optical specifications, the central processing unit 41 determines candidates of combinations of the curvature radii of the lenses to meet the condition of inequality (1). In FIG. 10, five candidates determined by the central processing unit 41 are output via the display device 45. Referring to FIG. 10, r₁ and r₂ indicate the curvature radii of the surfaces of the first lens; r₃ and r₄, the curvature radii of the surfaces of the second lens; r₅ and r₆, the curvature radii of the surfaces of the third lens; r₇ and r₈, the curvature radii of the surfaces of the fourth lens; and r₉ and r₁₀, the curvature radii of the surfaces of the fifth lens. The central processing unit 41 selects, from the determined candidates, a combination of curvature radii optimum for designing the optical system. The central processing unit 41 designs the optical system in accordance with the flowcharts of FIGS. 4A and 4B or the flowcharts of FIGS. 8A and 8B based on the selected combination of curvature radii. The optical specifications input to the central processing unit 41 via the input device 44 may include a lower limit value fₘᵢₙ and upper limit value fₘₐₓ of the allowable range of the focal length f or the curvature radii r of some of the lenses in addition to the focal length f, the focal length f, and the refractive indices N. As for the allowable range of the focal length f, a ratio X to allow a change in the focal length f may be input, and the allowable range may be defined based on the ratio X.

As described above, in the fourth embodiment, the computer 40 determines the candidates of combinations of curvature radii of the lenses based on input optical specifications. The computer 40 selects a combination optimum for designing the optical system from the candidates. The example of determining the initial data in the fourth embodiment and the example of determining the initial data in the third embodiment are selectively used in accordance with the prerequisite or design freedom in designing the optical system.

<Embodiment of Manufacturing Method of Optical System>

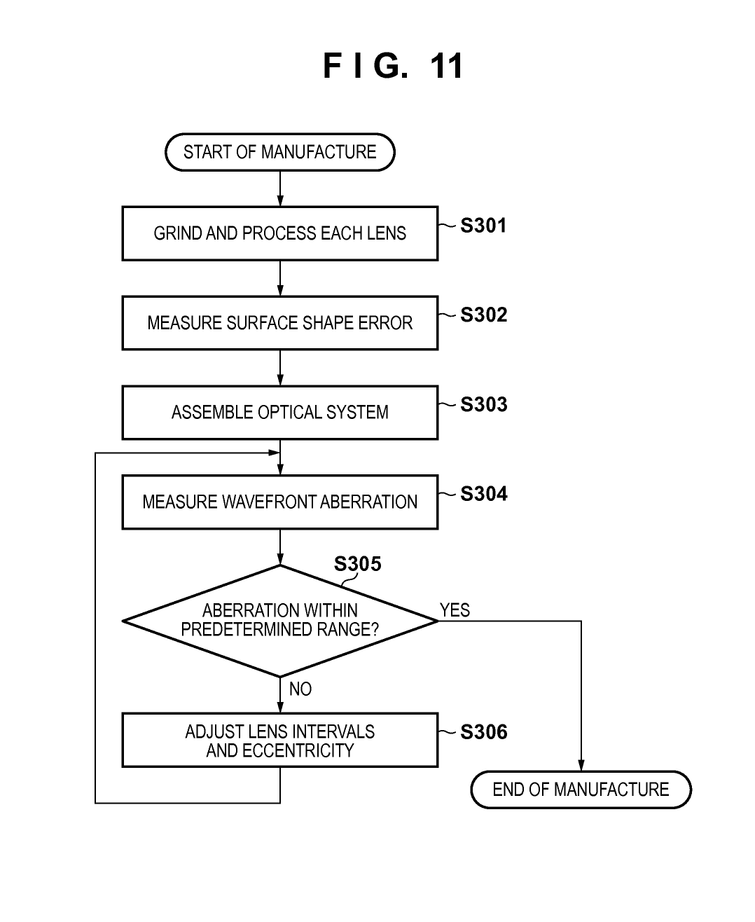

An exposure apparatus of an optical system according to an embodiment of the present invention will be described with reference to FIG. 11. FIG. 11 is a flowchart showing a manufacturing method of the optical system designed by the design method according to the first or second embodiment. In step S301, each lens of the optical system is manufactured based on the design data of the optical system designed by the design method of the first or second embodiment. Each lens uses the glass material determined in the first or second embodiment and ground as needed. The surfaces of each lens are polished aiming at the design data (lens thickness and curvature radii). In step S302, the shape of each lens is measured. It is judged whether the shape (lens thickness and curvature radii) of each lens matches the target shape. If the shape of each lens does not match the target shape, the process returns to step S301, and steps S301 and S302 are repeated until the shape of each lens matches the target shape. If the shape of each lens matches the target shape, the process advances to step S303. In step S303, the optical system is assembled using the plurality of lenses each having the target shape. For example, a plurality of optical units each formed from several lenses held by a holding frame are assembled based on the design data (lens intervals). The plurality of optical units are sequentially stored in a lens barrel from its opening and fixed. At this time, washers are inserted between the plurality of optical units based on the design data (lens intervals). The optical system is thus assembled based on the design data (glass materials, curvature radii, lens thicknesses, and lens intervals) of the optical system designed by the design method of the first or second embodiment.

In step S304, the wavefront aberration of the optical system assembled in step S303 is measured. The wavefront aberration of the optical system can be measured by an interferometer using, for example, a KrF excimer laser light source, an ArF excimer laser light source, or an ultra-high pressure mercury lamp (for example, i-line). As the interferometer, a Fizeau interferometer, a phase diffraction interferometer, or the like is usable. In step S305, it is judged whether the wavefront aberration of the optical system measured in step S304 falls within a predetermined range. If the wavefront aberration of the optical system falls within the predetermined range, the manufacture of the optical system ends. On the other hand, if the wavefront aberration of the optical system does not fall within the predetermined range, the process advances to step S306. In step S306, interval adjustment of moving the lenses along the optical axis and changing the lens intervals, eccentricity adjustment of shifting or tilting the lenses perpendicularly to the optical axis, and the like are performed. After the interval adjustment, eccentricity adjustment, and the like in step S306, the process returns to step S304 to measure the wavefront aberration of the optical system again.

As described above, in the manufacturing method of the optical system according to this embodiment, the lenses are processed and assembled based on the design data of the optical system designed by the design method of the first or second embodiment, thereby manufacturing the optical system. This makes it possible to manufacture the optical system in which the Seidel's five aberrations and the chromatic aberration are corrected, and the change in the imaging position caused by the environmental change is suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-229241 filed on Oct. 16, 2012, which is hereby incorporated by reference herein in its entirety.

1. A generation method of generating, by a computer, initial data to be used when designing an optical system in which a plurality of lenses are arranged in an optical axis direction,
wherein in an optical system model in which a thickness of each lens and intervals between the plurality of lenses are set to 0, letting m be the number of lenses, r₂ᵢ₋₁ and r₂ᵢ be curvature radii of two surfaces of an ith lens, respectively, and I₁ and I₂ be a first index and a second index, respectively, the curvature radii of each lens are generated as the initial data to meet a condition represented by an inequality
$${I}_{1} \leq {\sum }_{i = 1}^{m} ( \frac{1}{{r}_{2 i - 1}} - \frac{1}{{r}_{2 i}} ) \leq {I}_{2} .$$

2. The method according to claim 1, wherein letting fₘᵢₙ and fₘₐₓ be a lower limit value and an upper limit value of an allowable range of a focal length of the optical system, the first index I₁ and the second index I₂ are respectively given by
$${I}_{1} = - \frac{1}{{f}_{min}} , \qquad {I}_{2} = - \frac{1}{{f}_{max}} .$$

3. The method according to claim 1, wherein letting f be a focal length of the optical system, and X be an allowable ratio of a change in the focal length, the first index I₁ and the second index I₂ are respectively given by
$${I}_{1} - \frac{1}{( 1 - X ) \times f} , \qquad {I}_{2} = - \frac{1}{( 1 + X ) \times f} .$$

4. The method according to claim 1, wherein the curvature radii of each lens are generated such that an aberration of the optical system model having the curvature radii of each lens meets an allowable condition.

5. The method according to claim 1, wherein the intervals between the plurality of lenses in the optical system model having the curvature radii of each lens generated as the initial data are changed to further generate the changed intervals between the plurality of lenses as the initial data.

6. The method according to claim 5, wherein the curvature radii of each lens and the intervals between the plurality of lenses are generated such that an aberration of the optical system model having the curvature radii of each lens and the intervals between the plurality of lenses meets an allowable condition.

7. The method according to claim 1, wherein a difficulty when designing the optical system having target optical performance using the optical system model is obtained based on the condition represented by the inequality.

8. The method according to claim 1, wherein the initial data is generated by selecting the initial data from a plurality of data meeting the condition represented by the inequality.

9. A design method of designing, based on initial data, an optical system in which a plurality of lenses are arranged along an optical axis direction,
wherein the initial data is generated by a generation method comprising generating, by a computer, initial data to be used when designing an optical system in which a plurality of lenses are arranged in an optical axis direction,
wherein in an optical system model in which a thickness of each lens and intervals between the plurality of lenses are set to 0, letting m be the number of lenses r₂ᵢ₋₁ and r₂ᵢ be curvature radii of two surfaces of an ith lens respectively, and I₁ and I₂ be a first index and a second index, respectively, the curvature radii of each lens are generated as the initial data to meet a condition represented by an inequality
$$\underline{{I}_{1} \leq {\sum }_{i = 1}^{m} ( \frac{1}{{r}_{2 i - 1}} - \frac{1}{{r}_{2 i}} ) \leq {I}_{2}} .$$

10. A manufacturing method of an optical system in which a plurality of lenses are arranged along an optical axis direction,
wherein the plurality of lenses are processed based on design data of the optical system designed by a design method comprising
designing, based on initial data, an optical system in which a plurality of lenses are arranged along an optical axis direction,
wherein the initial data is generated by a generation method comprising generating, by a computer, initial data to be used when designing an optical system in which a plurality of lenses are arranged in an optical axis direction,
wherein in an optical system model in which a thickness of each lens and intervals between the plurality of lenses are set to 0, letting m be the number of lenses r₂ᵢ₋₁ and r₂ᵢ be curvature radii of two surfaces of an ith lens respectively and I₁ and I₂ be a first index and a second index, respectively, the curvature radii of each lens are generated as the initial data to meet a condition represented by an inequality
$$\underline{{I}_{1} \leq {\sum }_{i = 1}^{m} ( \frac{1}{{r}_{2 i - 1}} - \frac{1}{{r}_{2 i}} ) \leq {I}_{2}} .$$

11. A non-transitory computer-readable storage medium storing a program for causing a computer in an information processing apparatus to execute a method, the method generating, by a computer, initial data to be used when designing an optical system in which a plurality of lenses are arranged in an optical axis direction,
wherein in an optical system model in which a thickness of each lens and intervals between the plurality of lenses are set to 0, letting m be the number of lenses, r₂ᵢ₋₁ and r₂ᵢ be curvature radii of two surfaces of an ith lens, respectively, and I₁ and I₂ be a first index and a second index, respectively, the curvature radii of each lens are generated as the initial data to meet a condition represented by an inequality
$${I}_{1} \leq {\sum }_{i = 1}^{m} ( \frac{1}{{r}_{2 i - 1}} - \frac{1}{{r}_{2 i}} ) \leq {I}_{2} .$$
